(19) United States
(12) Patent Application Publication
(10) Pub. No.: US 2007/0209779 A1
(43) Pub. Date: Sep. 13, 2007

(54) Vehicle Air-Conditioning Related Technique Having Refrigeration Cycle of Supercritical Refrigerant

(75) Inventors: Etsuo Shinmura, Tochigi (JP); Yuichi Furukawa, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Showa Denko K.K., Tokyo (JP)

(21) Appl. No.: 10/581,527

(22) PCT Filed: Dec. 3, 2004
(86) PCT No.: PCT/JP04/18423

§ 371 Date: May 17, 2007

Related U.S. Application Data
(60) Provisional application No. 60/528,496, filed on Dec. 11, 2003.

(30) Foreign Application Priority Data
Dec. 5, 2003 (JP) 2003-407379

(51) Int. Cl. B60H 1/03; B60H 1/00; B60H 3/00; F25B 43/00

(52) U.S. Cl. 165/42; 165/41; 62/498; 62/502

(57) ABSTRACT

A vehicle air-conditioning apparatus in which supercritical refrigerant passing through a refrigerant heat releasing passage of a heat releasing device exchanges heat with refrigerant cooling air introduced from an air introduction surface of a heat releasing device to be cooled, and the cooled refrigerant exchanges heat with air to be introduced into a passenger compartment by an evaporator. Since at least a part of discharge air discharged from an inside of a passenger compartment is introduced from an air introduction surface of the heat releasing device as a ventilation loss utilizing air, ventilation loss utilizing air can be used as a part of refrigerant cooling air. The ventilation loss utilizing air is introduced to the downstream side area of the refrigerant heat releasing passage in an air introduction surface of the heat releasing device.

This application claims priority to Japanese Patent Application No. 2003-407379 filed on Dec. 5, 2003 and U.S. Provisional Application No. 60/528,496 filed on Dec. 11, 2003, the entire disclosures of which are incorporated herein by reference in their entireties.

### CROSS REFERENCE TO RELATED APPLICATIONS

This application is an application filed under 35 U.S.C.§111(a) claiming the benefit pursuant to 35 U.S.C.§119(e) (1) of the filing date of U.S. Provisional Application No. 60/528,496 filed on Dec. 11, 2003 pursuant to 35 U.S.C §111(b).

### BACKGROUND OF THE INVENTION

1. Field of the Invention

The present invention relates to a vehicle air-conditioning related technique having a refrigeration cycle using supercritical refrigerant such as CO₂ refrigerant, and more specifically relates to, for example, an air-conditioning apparatus for use in vehicles, an automobile equipped with the apparatus, a heat releasing device for use in vehicle air-conditioning systems and a vehicle air-conditioning method.

2. Description of the Related Art

The following description sets forth the inventor's knowledge of related art and problems therein and should not be construed as an admission of knowledge in the prior art.

In an automobile air-conditioning system, heat loss (ventilation loss) of discharge air occurs when the air is discharged from a passenger compartment for the purpose of ventilation during the operation of the air-conditioning system. This ventilation loss may reach about 30% of the overall heat load at the time of the cooling operation, causing additional power consumption, which in turn results in decreased mileage and drastically increased fuel consumption.

Under the circumstances, a means for effectively utilizing heat energy to be lost at the time of discharging air (i.e., at the time of ventilation) is proposed.

For example, in an air-conditioning system for use in automobiles disclosed by Japanese Unexamined Laid-open Patent Publication No. 5-294135, air discharged from a passenger compartment is introduced to a heat exchanger constituting a refrigeration cycle to exchange heat between the discharged air and refrigerant, to thereby reduce the ventilation loss.

In conventional vehicle refrigeration systems, most of them employ a steam compression type refrigeration cycle using Freon series refrigerant in which gaseous refrigerant compressed with a compressor is liquefied with a condenser and then the liquefied refrigerant is decompressed with a decompression device and then evaporated with an evaporator. The aforementioned air-conditioning system disclosed in the above-mentioned patent document can also be applied to a refrigeration cycle of Freon series refrigerant. For example, during the cooling operation of the passenger compartment, air discharged from the passenger compartment (discharged air) is introduced to the condenser of the above-mentioned refrigeration cycle to exchange heat between the discharged air and refrigerant in a condenser, to thereby condense and liquefy the refrigerant.

In recent years, from a viewpoint of earth environment protection, etc., a refrigeration cycle using natural refrigerant, such as carbon dioxide, has gotten a lot of attention. In the refrigeration cycle of this carbon-dioxide-gas refrigerant, unlike the refrigeration cycle using the above-mentioned Freon series refrigerant, the refrigerant compressed with the compressor operates in a supercritical state when it passes through a heat releasing device (condenser), and gradually decreases in temperature (sensible heat) while keeping the supercritical state without causing phase changes (condensation and liquefaction). As will be understood from the above, the carbon-dioxide-gas refrigerant changes in temperature without causing phase changes, and therefore the temperature difference between the refrigerant and the ambient air differs depending on the position where the refrigerant flows, and the heat exchange performance is easily influenced by the ambient temperature, etc. Accordingly, depending on air introductory conditions, the heat release amount of the refrigerant changes greatly, which in turn greatly changes the refrigeration performance of the overall refrigeration cycle.

Under such technical background, in a refrigeration cycle of carbon-dioxide-gas refrigerant, in cases where discharged air is merely introduced to a heat releasing device as disclosed in the aforementioned patent document, defects, such as variation and/or deviation of introductory air temperature and/or refrigerant temperature, occur, which in turn makes it difficult to obtain stable heat exchange performance. Consequently, the heat release amount of the refrigerant cannot fully be secured, resulting in inefficient reduction of ventilation loss, which in turn deteriorates energy utilization.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a vehicle air-conditioning apparatus having a refrigeration cycle utilizing supercritical refrigerant such as CO₂ refrigerant, capable of reducing ventilation loss and utilizing energy, an automobile equipped with the aforementioned air-conditioning apparatus, a vehicle air-conditioning heat releasing device and a vehicle air-conditioning method.

In order to attain the aforementioned objects, a first invention has the following structure.

[1] A vehicle air-conditioning apparatus, comprising:

a heat releasing device having a refrigerant heat releasing passage through which supercritical refrigerant passes to exchange heat with refrigerant cooling air introduced from an air introduction surface of the heat releasing device to be cooled; and

an evaporator by which the cooled refrigerant exchanges heat with air to be introduced in a passenger compartment,

wherein at least a part of discharge air discharged from an inside of the passenger compartment is introduced to the air introduction surface of the heat releasing device as ventilation loss utilizing air, so that the ventilation loss utilizing air is used as a part of the refrigerant cooling air, and

wherein the ventilation loss utilizing air is introduced to a downstream side area of the refrigerant heat releasing passage on the air introduction surface of the heat releasing device.

In the vehicle air-conditioning apparatus according to this invention, sufficient refrigerant heat release amount can secured, resulting in high refrigeration performance. That is, in a refrigeration cycle using supercritical refrigerant such as carbon-dioxide refrigerant, the refrigerant gradually decreases in temperature without changing the phase while passing through the refrigerant heat releasing passage of the heat releasing device. For this reason, at the upstream side of the refrigerant heat releasing passage, the refrigerant temperature can be kept high and the temperature difference between the ambient temperature and the refrigerant temperature can be kept large enough. This results in efficient heat exchange and sufficient heat release amount. Furthermore, at the downstream side of the refrigerant heat releasing passage, the refrigerant temperature is low and therefore the temperature difference with respect to the ambient temperature becomes small. However, in the present invention, discharge air of low temperature discharged from a passenger compartment is introduced to the downstream side area of the refrigerant heat releasing passage so as to exchange heat between the low temperature discharge air and the refrigerant. Therefore, the temperature difference between the refrigerant and the discharge air can be kept large, resulting in efficient heat exchange and sufficient heat release amount. Thus, at the entire area of the upstream side and downstream side of the refrigerant heat releasing passage in a heat releasing device, heat exchange can be efficiently performed between the refrigerant and the air, resulting in sufficient heat release amount and high refrigeration performance.

Moreover, in the present invention, since heat energy of discharge air discharged from a passenger compartment is utilized, ventilation loss can be reduced and energy can be utilized effectively.

[2] The vehicle air-conditioning apparatus as recited in the aforementioned Item [1], wherein an occupancy area ratio of an area to which the ventilation loss utilizing air is introduced with respect to the air introduction surface of the heat releasing device is set to 2 to 20%.

In cases where this structure is employed in this invention, heat exchange can be performed more efficiently, and still higher refrigeration performance can be obtained.

[3] The vehicle air-conditioning apparatus as recited in the aforementioned Item [1], wherein the ventilation loss utilizing air is introduced to an area including a downstream side end portion of the refrigerant heat releasing passage on the air introduction surface.

In cases where this structure is employed in this invention, still higher refrigeration performance can be obtained more assuredly.

[4] A vehicle air-conditioning apparatus, comprising:

first and second heat releasing devices each having a refrigerant heat releasing passage, wherein supercritical refrigerant passes through the first and second heat releasing devices in this order to exchange heat with refrigerant cooling air introduced from each air introduction surface of the first and second heat releasing devices to be cooled; and

an evaporator by which the refrigerant cooled by the second heat releasing device among the first and second heat releasing devices arranged at a refrigerant downstream side exchanges heat with air to be introduced into a passenger compartment,

wherein at least a part of discharge air discharged from an inside of the passenger compartment is introduced to the air introduction surface of the second heat releasing device as ventilation loss utilizing air, so that the ventilation loss utilizing air is used as a part of the refrigerant cooling air.

In this second invention, the same functions/effects as mentioned above can be obtained. Furthermore, in this invention, since the first and second heat releasing devices can be arranged at different positions, the heat releasing devices can be arranged freely in accordance with the desired layout, enhancing the versatility. Furthermore, in the present invention, it is preferable to employ the following Items [5] to [7].

[5] The vehicle air-conditioning apparatus as recited in the aforementioned Item [4], wherein an occupancy area ratio of the air introduction surface of the second heat releasing device with respect to a total area of the air introduction surfaces of the first and second heat releasing devices is set to 2 to 20%.

[6] The vehicle air-conditioning apparatus as recited in the aforementioned Item [4] or [5], wherein the first heat releasing device and the second heat releasing device are arranged apart from each other.

[7] The vehicle air-conditioning apparatus as recited in any one of the aforementioned Items [4] to [6], wherein one of the first heat releasing device and the second heat releasing device is arranged at a vehicle front portion, and the other heat releasing device is arranged at a vehicle rear portion.

[8] A vehicle air-conditioning apparatus, comprising:

a plurality of heat releasing devices each having a refrigerant heat releasing passage, wherein supercritical refrigerant passes through the plurality of heat releasing devices in order to exchange heat with refrigerant cooling air introduced from each air introduction surface of the plurality of heat releasing devices to be cooled; and

an evaporator by which the refrigerant cooled by a final staged heat releasing device among the plurality of heat releasing devices arranged at a refrigerant downstream side exchanges heat with air to be introduced into a passenger compartment,

wherein at least a part of discharge air discharged from an inside of the passenger compartment is introduced to an air introduction surface of the final staged heat releasing device as ventilation loss utilizing air, so that the ventilation loss utilizing air is used as a part of the refrigerant cooling air.

In this third invention, the same functions/effects as mentioned above can be obtained. Furthermore, in this invention, since the first and second heat releasing devices can be arranged at different positions, the heat releasing devices can be arranged freely in accordance with the desired layout, enhancing the versatility. Furthermore, in the present invention, it is preferable to employ the following Item [9].

[9] The vehicle air-conditioning apparatus as recited in the aforementioned Item [8], wherein an occupancy area ratio of the air introduction surface of the final staged heat releasing device with respect to the total area of the air introduction surfaces of the plurality of heat releasing devices is set to 2 to 20%.

[10] A vehicle air-conditioning apparatus, comprising:

first and second heat releasing devices each having a refrigerant heat releasing passage, wherein supercritical refrigerant passes through the first and second heat releasing devices in this order to exchange heat with refrigerant cooling air introduced from each air introduction surface of the first and second heat releasing devices to be cooled; and

an evaporator by which the refrigerant cooled by the second heat releasing device among the first and second heat releasing devices arranged at a refrigerant downstream side exchanges heat with air to be introduced into a passenger compartment,

wherein at least a part of discharge air discharged from an inside of the passenger compartment is introduced to the air introduction surface of the second heat releasing device as ventilation loss utilizing air, so that the ventilation loss utilizing air is used as a part of the refrigerant cooling air, and

wherein the ventilation loss utilizing air is introduced to a downstream side area of the refrigerant heat releasing passage on the air introduction surface of the second heat releasing device.

In this fifth invention, the same functions/effects as mentioned above can be obtained.

[11] A vehicle air-conditioning apparatus, comprising:

a plurality of heat releasing devices each having a refrigerant heat releasing passage, wherein supercritical refrigerant passes through the plurality of heat releasing devices in order to exchange heat with refrigerant cooling air introduced from each air introduction surface of the plurality of heat releasing devices to be cooled; and

an evaporator by which the refrigerant cooled by a final staged heat releasing device among the plurality of heat releasing devices arranged at a refrigerant downstream side exchanges heat with air to be introduced in a passenger compartment,

wherein at least a part of discharge air discharged from an inside of the passenger compartment is introduced to the air introduction surface of the final staged heat releasing device as ventilation loss utilizing air, so that the ventilation loss utilizing air is used as a part of the refrigerant cooling air, and

wherein the ventilation loss utilizing air is introduced to a downstream side area of the refrigerant heat releasing passage on the air introduction surface of the final staged heat releasing device.

In this sixth invention, the same functions/effects as mentioned above can be obtained. In each of the aforementioned inventions, it is preferable to employ the flowing Item [12].

[12] The vehicle air-conditioning apparatus as recited in any one of the aforementioned Items [1] to [11], wherein CO₂ refrigerant is used as the supercritical refrigerant.

[13] A vehicle air-conditioning heat releasing device, comprising:

a refrigerant heat releasing passage through which supercritical refrigerant passes; and

an air introduction surface for introducing refrigerant cooling air,

wherein the supercritical refrigerant passing through the refrigerant heat releasing passage exchanges heat with the refrigerant cooling air introduced from the air introduction surface,

wherein at least a part of discharge air discharged from an inside of a passenger compartment is introduced to the air introduction surface as ventilation loss utilizing air, so that the ventilation loss utilizing air is used as a part of the refrigerant cooling air, and

wherein a discharge air introduction area for introducing the ventilation loss utilizing air is provided at a downstream side area of the refrigerant heat releasing passage on the air introduction surface of the heat releasing device.

This seventh invention specifies a heat releasing device applicable to the aforementioned vehicle air-conditioning apparatus of the invention, and therefore the same functions/effects as mentioned above can be obtained. Moreover, in this invention, it is preferable to employ the following Items [14] to [16].

[14] The vehicle air-conditioning heat releasing device as recited in the aforementioned Item [13], wherein an occupancy area ratio of the discharge air introduction area with respect to the total area is set to 2 to 20%.

[15] The vehicle air-conditioning heat releasing device as recited in the aforementioned Item [13] or [14], wherein the discharge air introduction area is provided at an area including a downstream side end portion of the refrigerant heat releasing passage on the air introduction surface.

[16] The vehicle air-conditioning heat releasing device as recited in any one of the aforementioned Items [13] to [15], wherein CO₂ refrigerant is used as the supercritical refrigerant.

[17] A vehicle air-conditioning method in which supercritical refrigerant passing through a heat releasing passage of a heat releasing device exchanges heat with refrigerant cooling air introduced to an air introduction surface of the heat releasing device to be cooled, and the cooled refrigerant exchanges heat with air to be introduced into a passenger compartment by an evaporator,

wherein at least a part of discharge air discharged from an inside of the passenger compartment is introduced to an air introduction surface of the heat releasing device as ventilation loss utilizing air so as to utilize the ventilation loss utilizing air as a part of the refrigerant cooling air; and

wherein the ventilation loss utilizing air is introduced to a downstream side area of the refrigerant heat releasing passage on the air introduction surface of the heat releasing device.

In the vehicle air-conditioning method of the eighth invention, the same functions/effects as mentioned above can be obtained.

[18] A vehicle air-conditioning method in which supercritical refrigerant passing through each refrigerant heat releasing passage of first and second heat releasing devices in order exchanges heat with refrigerant cooling air introduced to each air introduction surface of the first and second heat releasing devices to be cooled, and the refrigerant cooled by the second heat releasing device arranged at a refrigerant downstream side among the first and second heat releasing devices exchanges heat with air to be introduced into a passenger compartment by an evaporator,

wherein at least a part of discharge air discharged from an inside of the passenger compartment is introduced to the air introduction surface of the second heat releasing device as ventilation loss utilizing air so as to utilize the ventilation loss utilizing air as a part of the refrigerant cooling air.

In the vehicle air-conditioning method of the ninth invention, the same functions/effects as mentioned above can be obtained.

[19] A vehicle air-conditioning method in which supercritical refrigerant passing through each refrigerant heat releasing passage of a plurality of heat releasing devices in order exchanges heat with refrigerant cooling air introduced to each air introduction surface of the plurality of heat releasing devices to be cooled, and the refrigerant cooled by the final staged heat releasing device arranged at a refrigerant downstream side among the a plurality of heat releasing devices exchanges heat with air to be introduced into a passenger compartment by an evaporator,

wherein at least a part of discharge air discharged from an inside of the passenger compartment is introduced to the air introduction surface of the final staged heat releasing device as ventilation loss utilizing air so as to utilize the ventilation loss utilizing air as a part of the refrigerant cooling air.

In the vehicle air-conditioning method of the tenth invention, the same functions/effects as mentioned above can be obtained.

[20] A vehicle air-conditioning method in which supercritical refrigerant passing through each refrigerant heat releasing passage of first and second heat releasing devices in order exchanges heat with refrigerant cooling air introduced from each air introduction surface of the first and second heat releasing devices to be cooled, and the refrigerant cooled by the second heat releasing device arranged at a refrigerant downstream side among the first and second heat releasing devices exchanges heat with air to be introduced into a passenger compartment by an evaporator,

wherein at least a part of discharge air discharged from an inside of the passenger compartment is introduced to the air introduction surface of the second heat releasing device as ventilation loss utilizing air so as to utilize the ventilation loss utilizing air as a part of the refrigerant cooling air, and

wherein the ventilation loss utilizing air is introduced to a downstream side area of the refrigerant heat releasing passage on the air introduction surface of the second heat releasing device.

In the vehicle air-conditioning method of the eleventh invention, the same functions/effects as mentioned above can be obtained.

[21] A vehicle air-conditioning method in which supercritical refrigerant passing through each refrigerant heat releasing passage of a plurality of heat releasing devices in order exchanges heat with refrigerant cooling air introduced to each air introduction surface of the plurality of heat releasing devices to be cooled, and the refrigerant cooled by a final staged heat releasing device arranged at a refrigerant downstream side among the a plurality of heat releasing devices exchanges heat with air to be introduced into a passenger compartment by an evaporator,

wherein at least a part of discharge air discharged from an inside of the passenger compartment is introduced to the air introduction surface of the final staged heat releasing device as ventilation loss utilizing air so as to utilize the ventilation loss utilizing air as a part of the refrigerant cooling air, and

wherein the ventilation loss utilizing air is introduced to a downstream side area of the refrigerant heat releasing passage on the air introduction surface of the final staged heat releasing device.

In the vehicle air-conditioning method of the twelfth invention, the same functions/effects as mentioned above can be obtained.

In the vehicle air-conditioning method according to the present invention, it is preferable to employ the following Item [22].

[22] A vehicle air-conditioning method as recited in any one of the aforementioned Items [17] to [21], wherein CO₂ refrigerant is used as the supercritical refrigerant.

[23] A vehicle equipped with the vehicle air-conditioning apparatus as recited in any one of the aforementioned Items [1] to [12].

This thirteenth invention specifies an automobile equipped with the vehicle air-conditioning apparatus of the aforementioned invention, and therefore the same functions/effects as mentioned above can be obtained.

According to the first to thirteenth inventions, sufficient refrigerant heat release amount can be secured, and ventilation loss can be reduced while improving refrigeration performance. Thus, energy can be utilized effectively.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic structural view of an air-conditioning system of an automobile employing an air-conditioning apparatus according to an embodiment of the present invention;

FIG. 2 is a perspective view showing a heat releasing device employed in the embodiment;

FIG. 3 is a schematic structural view of an air-conditioning system of an automobile employing an air-conditioning apparatus according to a first modified embodiment of the present invention;

FIG. 4 is a schematic structural view of an air-conditioning system of an automobile employing an air-conditioning apparatus according to a second modified embodiment of the present invention;

FIG. 5 is a schematic structural view of an air-conditioning system of an automobile employing an air-conditioning apparatus according to a third modified embodiment of the present invention;

FIG. 6 is a graph showing a relation between a refrigerant temperature and a position of the refrigerant on the heat releasing passage in a heat releasing device related to the embodiment;

FIG. 7 is an enlarged view of the portion surrounded by a long dashed short dashed line P in FIG. 6;

FIG. 8 is an enlarged view of the portion surrounded by a long dashed short dashed line Q in FIG. 6; and

FIG. 9 is a graph showing a relation between the heat exchange amount and a heat exchange amount and an occupancy area ratio of a discharge air introduction area in a heat releasing device according to an embodiment.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

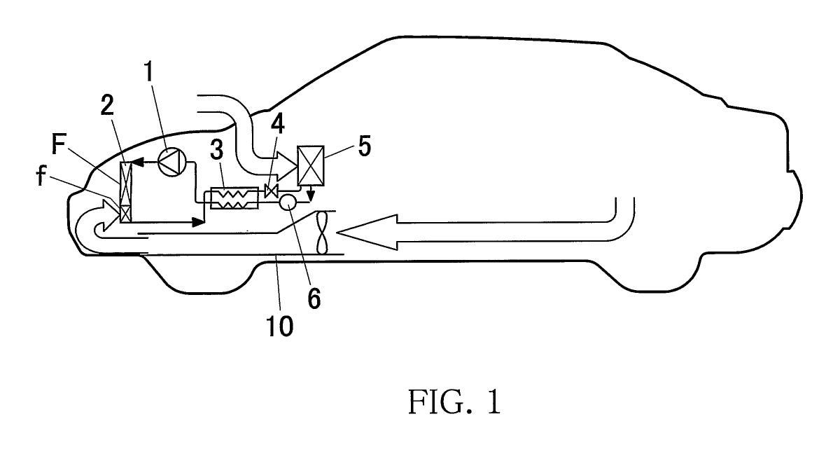

FIG. 1 is a schematic structural view showing an automobile air-conditioning system employing an air-conditioning apparatus according to an embodiment of the present invention. This refrigeration cycle employed in this automobile utilizes supercritical refrigerant, such as carbon-dioxide-gas (CO₂) refrigerant, and includes a compressor 1, a heat releasing device 2, an intermediate heat exchanger 3, an expansion valve 4, an evaporator 5 and an accumulator 6 as shown in FIG. 1.

In this refrigeration cycle, the refrigerant in a supercritical state compressed by the compressor 1 radiates heat by exchanging heat with refrigerant cooling air, such as ambient air, while passing through the heat releasing device 2, to reduce the temperature while keeping the supercritical state. The low-temperature refrigerant passes through the intermediate heat exchanger 3 and exchanges heat with return refrigerant, which will be mentioned later, to be further cooled. Thereafter, the cooled refrigerant is decompressed and expanded by the expansion valve 4 to be flowed into the evaporator 5. The refrigerant passing through the evaporator 5 exchanges heat with the air to be introduced into a compartment taken in from the outside of the car to absorb the heat. This increases the dryness to cause a phase change of the refrigerant into a gaseous phase, and then the gaseous phase refrigerant is introduced into the accumulator 6. The refrigerant (return refrigerant) flowed out of the accumulator 6 is introduced into the intermediate heat exchanger 3 to exchange heat with the aforementioned refrigerant (forward refrigerant) fed into the intermediate heat exchanger 3 from the aforementioned heat releasing device 2, to thereby further increase the temperature. Then, the refrigerant returns to the aforementioned compressor 1.

In this system, the air to be introduced into a compartment will be cooled by exchanging heat with the refrigerant and then introduced into the passenger compartment.

In this embodiment, the air-conditioning system is provided with a forced draft duct 10, such as a fan duct, for forcibly forwarding the discharge air, which is used to be discharged from the inside of the passenger compartment to the outside at the time of ventilation, to the air introduction side of the heat releasing device 2.

Thus, in addition to ambient air directly introduced from an outside of the car, the discharge air discharged from the passenger compartment is introduced to the heat releasing device 2 as refrigerant cooling air. Thus, the cooling air and the refrigerant in the heat releasing device 2 exchange heat.

In this embodiment, the discharge air among refrigerant cooling air is introduced to the area corresponding to the downstream side of the refrigerant heat releasing passages of the heat releasing device 2.

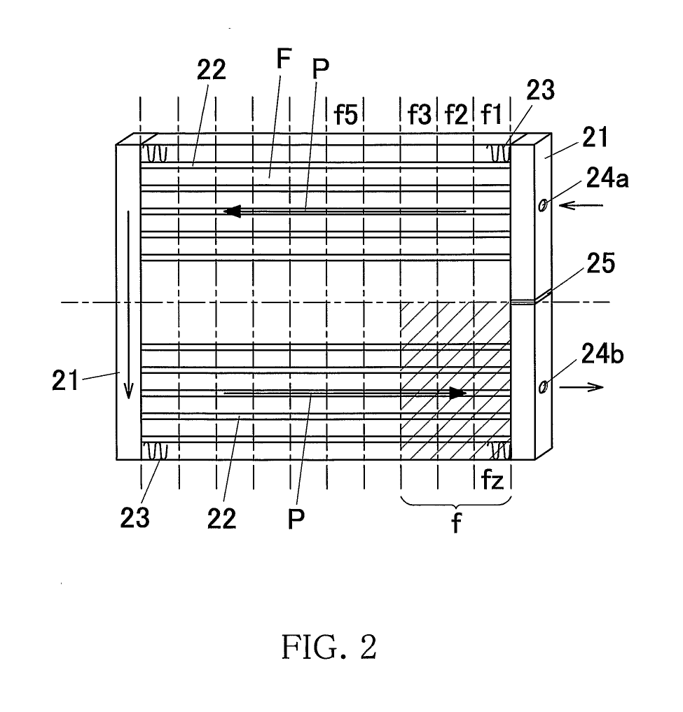

That is, in this embodiment, as shown in FIG. 2, as the heat releasing device 2, the so-called header-type heat exchanger is used. This heat releasing device 2 is provided with a pair of headers 21 and 21 disposed at a certain interval in parallel, and a plurality of flat heat exchanging tubes 22 disposed at certain intervals in parallel with the opposite ends communicated with the headers 21 and 21. Furthermore, between adjacent heat exchanging tubes 22 and 22, a corrugated fin 23 is disposed. At the upper and lower sides of the one (right-hand side) header 21, a refrigerant input 24a and a refrigerant output 24b are provided, respectively.

In the intermediate position of the one (right-hand side) header 21, a partitioning plate 25 for partitioning the header inside is provided. With this partitioning plate 25, the plurality of heat exchanging tubes 22 are classified into the upper and lower side tube groups constituting a first path and a second path, respectively.

Moreover, the front side area of the heat releasing device 2 (core portion) where the heat exchanging tubes 22 are arranged constitutes an air introduction surface F.

In this heat releasing device 2, the refrigerant introduced via the refrigerant inlet 24a flows into the upper part of the one (right-hand side) header 21, then passes through the refrigerant heat releasing passages P constituting an upper tube group (first path) to be introduced into the upper part of the other (left-hand side) header 21 and then to the lower part thereof. Subsequently, the refrigerant flows through the refrigerant heat releasing passages P constituting a lower tube group (second path) to be introduced into the lower part of the one (right-hand side) header 21, and then flows out of the refrigerant outlet 24b.

While passing through each tube 22, i.e., each refrigerant heat releasing passage P, the refrigerant exchanges heat with the refrigerant cooling air introduced from the air introduction surface F and passing between the tubes 22 and fins 23 to release the heat.

In this embodiment, as described above, in addition to the ambient air to be directly introduced from the outside of the car, the discharge air discharged from the passenger compartment is introduced to the refrigerant introduction surface F. In detail, it is configured such that the discharge air is introduced to the area f (hatched portion shown in FIG. 2) corresponding to the downstream side of the refrigerant heat releasing passages P of the refrigerant introduction surface F, i.e., the area f corresponding to the outlet side and therearound of the refrigerant heat releasing passages P of the refrigerant introduction surface F. This structure enables the refrigerant heat release amount to be sufficiently secured, resulting in high refrigeration performance. In other words, in the refrigeration cycle using supercritical refrigerant, such as CO₂ refrigerant, the refrigerant temperature gradually drops without causing phase changes while passing through the refrigerant heat releasing passages P of the heat releasing device 2. Accordingly, in this embodiment, at the upstream side of the refrigerant heat releasing passages P, the refrigerant temperature is high, and therefore the temperature difference between the ambient temperature and the refrigerant temperature can be kept large, enabling efficient heat exchange. As a result, sufficient heat release amount can be secured. In general, at the downstream side of the refrigerant heat releasing passages P, the refrigerant temperature becomes lower and the temperature difference between the refrigerant temperature and the ambient temperature becomes smaller.

In this embodiment, however, the low temperature discharge air discharged from the passenger compartment is introduced to the downstream area f of the refrigerant heat releasing passages P to exchange heat between the low temperature discharge air and the refrigerant. Accordingly, the temperature difference between the refrigerant and the discharge air can be kept larger, enabling efficient heat exchange, which in turn can secure sufficient heat release amount. Thus, at the entire area of the upstream and downstream sides of the refrigerant heat releasing passages P of the heat releasing device 2, heat exchange can be efficiently performed between the refrigerant and the ambient air. Therefore, sufficient heat release amount can be secured, thereby increasing enthalpy difference between the inlet and outlet of the heat releasing device 2. Thus, high refrigeration performance can be obtained.

Furthermore, in this embodiment, since heat energy of the discharge air is utilized, the ventilation loss can be reduced, enabling efficient energy utilization and energy saving, which in turn can improve fuel consumption.

Here, as shown in FIG. 2, in this embodiment, it is preferable that the downstream side area f of the refrigerant heat releasing passages P includes the downstream side end portion area fz of the refrigerant heat releasing passages P, i.e., the outlet side end portion area fz of the refrigerant heat releasing passages P.

Concretely, in this embodiment, assuming that the refrigerant introduction surface F of the heat releasing device 2 is classified into a plurality of areas f1, f2, . . . fz along the flow direction of the refrigerant heat releasing passages P, it is preferable that the introductory area f of the discharge air includes the downstream end portion area fz of the refrigerant heat releasing passages P.

Furthermore, in this embodiment, the occupancy area ratio of the introductory area f of the discharge air on the refrigerant introduction surface F is preferably set to 2 to 20%, more preferably 4 to 16%, optimally 6 to 12%, because of the following reasons. If this occupancy area ratio is too small, the thermal effect of the discharge air becomes hard to be obtained, causing inefficient heat exchange between the discharge air and the refrigerant. This may result in insufficient increased heat release amount of the refrigerant. To the contrary, if the occupancy area ratio is too large, the heat release amount of the refrigerant may not be fully improved. In other words, since the quantity of the air (airflow) discharged from the passenger compartment is constant, if the spray area of the discharge air against the heat releasing device 2 becomes large, the airflow decreases, which may cause insufficient increased heat release amount of the refrigerant.

In FIG. 2, for the purpose of facilitating the understanding of the invention, although the refrigerant introduction surface F is classified into a plurality of areas f1, f2, . . . , fz with virtual lines, it should be noted that in the present invention the number of classification of the area is not limited to the above.

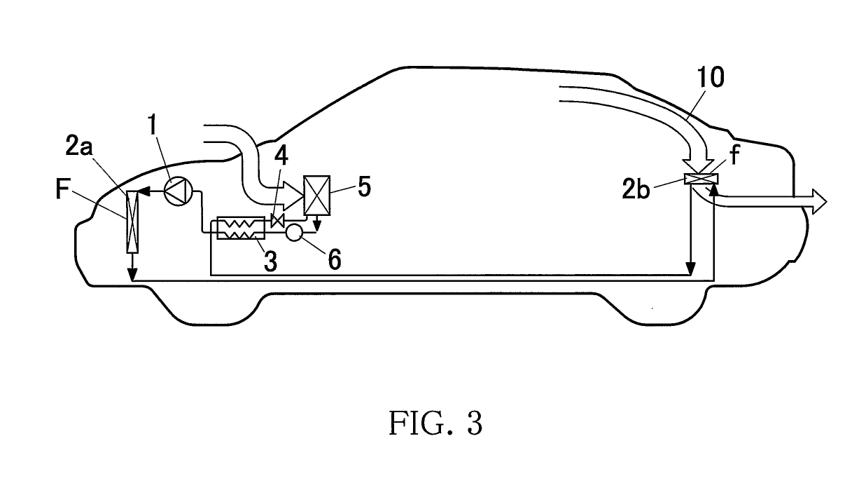

FIG. 3 is a schematic structural view of an automobile employing an air-conditioning system according to a first modification of the present invention. As shown in FIG. 3, in this air-conditioning system, a heat releasing device is constituted by two heat releasing devices, i.e., a first heat releasing device 2a arranged at the front portion of the automobile and a second heat releasing device 2b arranged at the rear portion of the automobile, and the system is constituted such that the refrigerant cooled by the first heat releasing device 2a flows into the second heat releasing device 2b to release the heat. Furthermore, in this modification, it is constituted such that the discharge air discharged from a passenger compartment is introduced to the entire area of the air introduction surface of the second heat releasing device 2b.

The other structure is the same as that of the aforementioned embodiment.

According to this automobile air-conditioning system, in the same manner as in the aforementioned embodiment, the refrigerant heat release amount can be fully secured and the ventilation loss can be reduced while improving the refrigeration performance, whereby effective use of energy can be attained. Furthermore, by dividing a heat releasing device into two heat releasing devices 2a and 2b, the size and weight of each heat releasing device can be decreased. In addition, these two heat releasing devices 2a and 2b can be freely arranged in accordance with a desired layout, which can expand the versatility.

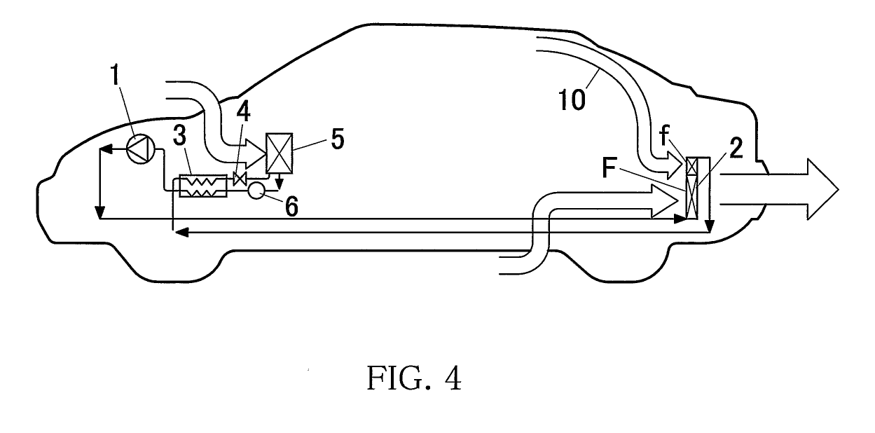

FIG. 4 shows a schematic structural view showing an automobile employing an air-conditioning system according to a second modification of the present invention. In this air-conditioning system, the heat releasing device 2 is arranged at the rear side of the automobile. The other structure is the same as that of the aforementioned embodiment.

Also in this vehicle air-conditioning system, the same functions/effects can be obtained in the same manner as in the aforementioned embodiments.

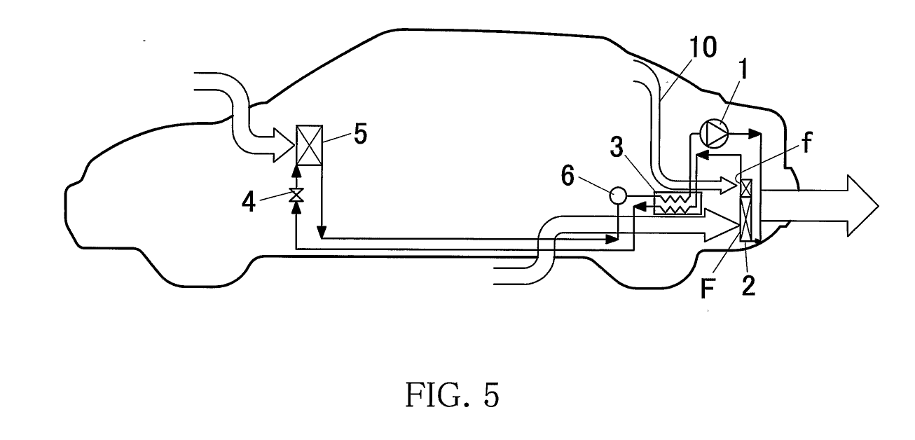

FIG. 5 shows a schematic structural view showing an automobile employing an air-conditioning system according to a third modification of the present invention. In this air-conditioning system, an expansion valve 4 and an evaporator 5 are arranged at the front portion of the automobile, and the other air-conditioning apparatuses, i.e., a compressor 1, a heat releasing device 2, an intermediate heat exchanger 3, and an accumulator 6 are arranged at the rear portion of the automobile. The other structure is the same as that of the aforementioned embodiments.

Also in this automobile air-conditioning system, the same functions/effects can be obtained in the same manner as in the aforementioned embodiments.

Although structure that a heat releasing device is constituted by one or two heat releasing devices is exemplified in the aforementioned embodiments, the present invention is not limited to the above, and can be constituted such that a heat releasing device is constituted by three or more heat releasing devices.

Furthermore, in cases where a heat releasing device is constituted by two or more heat releasing devices, it can be configured such that discharge air is introduced to a part of the air introduction surface of the final staged heat releasing device.

Moreover, in the aforementioned embodiments, although it is configured such that all the air discharged from the passenger compartment is sent to a heat releasing device, the present invention is not limited to them, and can be configured such that at least a part of the discharge air is introduced to a heat releasing device.

<Evaluation Experiment 1>

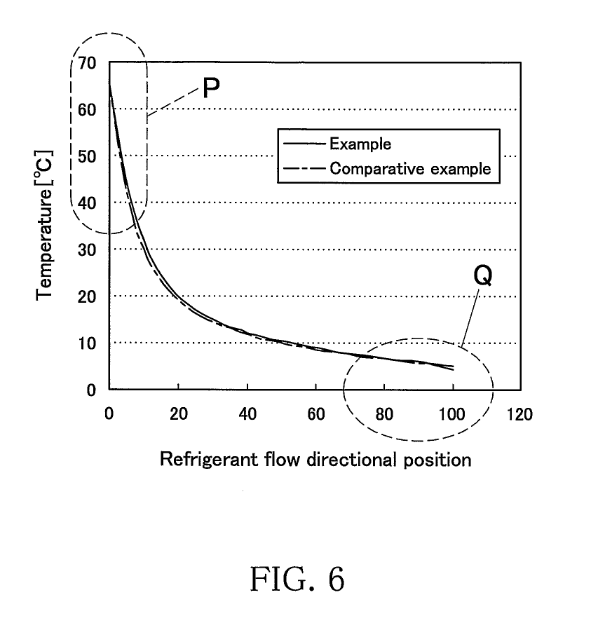

In this example, a heat releasing device 2 according to the aforementioned embodiment was used. Discharge air was introduced to the downstream side area f of the refrigerant heat releasing passages P on the refrigerant introduction surface F of the heat releasing device 2, and ambient air was introduced to the remaining area. The relation between the temperature of CO₂ refrigerant ranging from the heat releasing passage inlet side to the outlet side and the refrigerant position (refrigerant flow directional position) of the refrigerant in the heat releasing passage was obtained by computer simulation. At this time, it was set such that the introductory area of the discharge air included the downstream end portion area fz of the refrigerant heat releasing passages and that the occupancy area ratio thereof fell within 15% of the entire area of the refrigerant heat releasing passages. The results are shown in the graph of FIG. 6.

As a comparative example, discharge air was introduced to the upstream side area of the refrigerant heat releasing passages P, and ambient air was introduced to the remaining area. The relation between the refrigerant temperature and the position thereof was obtained. At this time, it was configured such that the introductory area of the discharge air included the upstream end portion area of the refrigerant heat releasing passages f1 and the occupancy area ratio fell within 15% of the entire area of the refrigerant heat releasing passages. The results are also shown in the graph of FIG. 6. In the horizontal axis of this graph, the position of the value “0” denotes the position of the inlet-side end portion (the position of the upstream side end portion) of the refrigerant heat releasing passages, and the position of the value “100” denotes the position of the outlet-side end portion (position of the downstream side end position) of the refrigerant heat releasing passages.

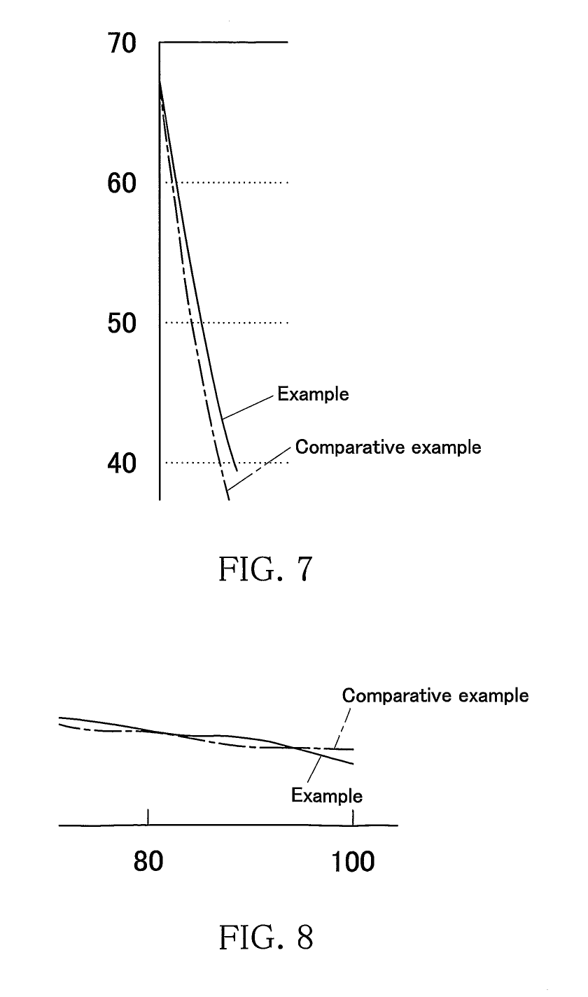

As will be understood from this graph, in the heat releasing device of the example shown with a solid line, although the temperature fall is small at the vicinity of the inlet side of the refrigerant heat releasing passages as compared with the heat releasing device of the comparative example shown with a alternate long and short dash line (see the enlarged view of FIG. 7), at the vicinity of the outlet of the refrigerant heat releasing passages, the temperature fall is large and the temperature difference between the inlet side temperature and the outlet side temperature is large (see the enlarged view of FIG. 8). That is, it is understood that according to the heat releasing device of an example, as compared with the device of the comparative example, heat release amount is large and therefore high refrigeration performance can be obtained.

<Evaluation experiment 2>

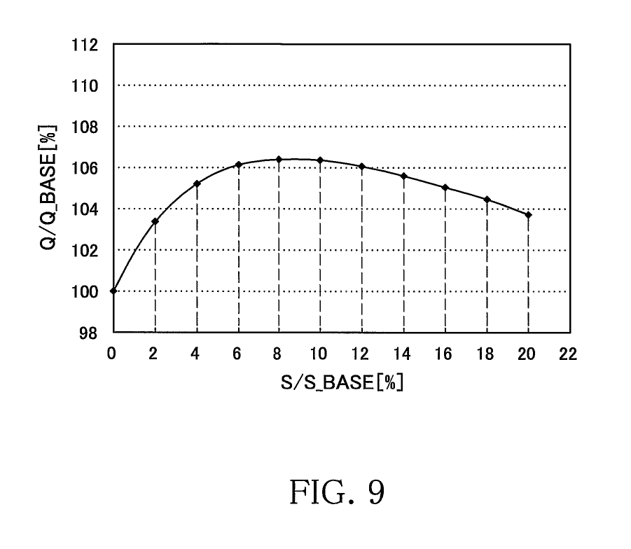

In this example, a heat releasing device 2 according to the aforementioned embodiment was used. The relation between the monopoly area rate of the introductory area f of discharge air and the increase rate of the heat exchange amount at the refrigerant introduction surface F of the heat releasing device 2 was obtained by computer simulation. At this time, the introductory area of discharge air included the downstream end portion area fz of a refrigerant heat releasing passage. The result is shown in the graph of FIG. 9. In this graph, the horizontal axis shows the monopoly area rate (S/S_BASE) [%] of the introductory area f of discharge air, and the horizontal axis shows the increase rate (Q/Q_BASE) [%] of heat exchange amount, i.e., the heat exchange amount [%] of the heat releasing device at the time of changing the occupancy area ratio when it is assumed that the heat exchange amount of the heat releasing device at the time of not using discharge air but introducing ambient air to the entire refrigerant introduction surface F was 100%.

As can be understood from this graph, when the occupancy area ratio is 2 to 20%, the heat exchange amount is large, and when the occupancy area ratio is 4 to 16%, the heat exchange amount is larger. Especially, when the occupancy area ratio is 6 to 12%, as compared with the usual heat releasing device (100% of heat release amount), the heat exchange amount is larger by 6% or more.

### INDUSTRIAL APPLICABILITY

As mentioned above, according to the vehicle air-conditioning related technique having a refrigeration cycle using supercritical refrigerant, such as CO₂ refrigerant according to the present invention, sufficient heat release amount of the refrigerant can be secured and the ventilation loss can be reduced while improving the refrigeration performance, and energy can be utilized effectively. Accordingly, it can be suitably used for vehicle air-conditioning system.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A vehicle air-conditioning apparatus, comprising:
a heat releasing device having a refrigerant heat releasing passage through which supercritical refrigerant passes to exchange heat with refrigerant cooling air introduced from an air introduction surface of the heat releasing device to be cooled; and
an evaporator by which the cooled refrigerant exchanges heat with air to be introduced in a passenger compartment,
wherein at least a part of discharge air discharged from an inside of the passenger compartment is introduced to the air introduction surface of the heat releasing device as ventilation loss utilizing air, so that the ventilation loss utilizing air is used as a part of the refrigerant cooling air, and
wherein the ventilation loss utilizing air is introduced to a downstream side area of the refrigerant heat releasing passage on the air introduction surface of the heat releasing device.

2. The vehicle air-conditioning apparatus as recited in claim 1, wherein an occupancy area ratio of an area to which the ventilation loss utilizing air is introduced with respect to the air introduction surface of the heat releasing device is set to 2 to 20%.

3. The vehicle air-conditioning apparatus as recited in claim 1, wherein the ventilation loss utilizing air is introduced to an area including a downstream side end portion of the refrigerant heat releasing passage on the air introduction surface.

4. A vehicle air-conditioning apparatus, comprising:
first and second heat releasing devices each having a refrigerant heat releasing passage, wherein supercritical refrigerant passes through the first and second heat releasing devices in this order to exchange heat with refrigerant cooling air introduced from each air introduction surface of the first and second heat releasing devices to be cooled; and
an evaporator by which the refrigerant cooled by the second heat releasing device among the first and second heat releasing devices arranged at a refrigerant downstream side exchanges heat with air to be introduced into a passenger compartment,
wherein at least a part of discharge air discharged from an inside of the passenger compartment is introduced to the air introduction surface of the second heat releasing device as ventilation loss utilizing air, so that the ventilation loss utilizing air is used as a part of the refrigerant cooling air.

5. The vehicle air-conditioning apparatus as recited in claim 4, wherein an occupancy area ratio of the air introduction surface of the second heat releasing device with respect to a total area of the air introduction surfaces of the first and second heat releasing devices is set to 2 to 20%.

6. The vehicle air-conditioning apparatus as recited in claim 4, wherein the first heat releasing device and the second heat releasing device are arranged apart from each other.

7. The vehicle air-conditioning apparatus as recited in claim 4, wherein one of the first heat releasing device and the second heat releasing device is arranged at a vehicle front portion, and the other heat releasing device is arranged at a vehicle rear portion.

8. A vehicle air-conditioning apparatus, comprising:
a plurality of heat releasing devices each having a refrigerant heat releasing passage, wherein supercritical refrigerant passes through the plurality of heat releasing devices in order to exchange heat with refrigerant cooling air introduced from each air introduction surface of the plurality of heat releasing devices to be cooled; and
an evaporator by which the refrigerant cooled by a final staged heat releasing device among the plurality of heat releasing devices arranged at a refrigerant downstream side exchanges heat with air to be introduced into a passenger compartment,
wherein at least a part of discharge air discharged from an inside of the passenger compartment is introduced to an air introduction surface of the final staged heat releasing device as ventilation loss utilizing air, so that the ventilation loss utilizing air is used as a part of the refrigerant cooling air.

9. The vehicle air-conditioning apparatus as recited in claim 8, wherein an occupancy area ratio of the air introduction surface of the final staged heat releasing device with respect to the total area of the air introduction surfaces of the plurality of heat releasing devices is set to 2 to 20%.

10. A vehicle air-conditioning apparatus, comprising:
first and second heat releasing devices each having a refrigerant heat releasing passage, wherein supercritical refrigerant passes through the first and second heat releasing devices in this order to exchange heat with refrigerant cooling air introduced from each air introduction surface of the first and second heat releasing devices to be cooled; and
an evaporator by which the refrigerant cooled by the second heat releasing device among the first and second heat releasing devices arranged at a refrigerant downstream side exchanges heat with air to be introduced into a passenger compartment,
wherein at least a part of discharge air discharged from an inside of the passenger compartment is introduced to the air introduction surface of the second heat releasing device as ventilation loss utilizing air, so that the ventilation loss utilizing air is used as a part of the refrigerant cooling air, and
wherein the ventilation loss utilizing air is introduced to a downstream side area of the refrigerant heat releasing passage on the air introduction surface of the second heat releasing device.

11. A vehicle air-conditioning apparatus, comprising:
a plurality of heat releasing devices each having a refrigerant heat releasing passage, wherein supercritical refrigerant passes through the plurality of heat releasing devices in order to exchange heat with refrigerant cooling air introduced from each air introduction surface of the plurality of heat releasing devices to be cooled; and
an evaporator by which the refrigerant cooled by a final staged heat releasing device among the plurality of heat releasing devices arranged at a refrigerant downstream side exchanges heat with air to be introduced in a passenger compartment,
wherein at least a part of discharge air discharged from an inside of the passenger compartment is introduced to the air introduction surface of the final staged heat releasing device as ventilation loss utilizing air, so that the ventilation loss utilizing air is used as a part of the refrigerant cooling air, and
wherein the ventilation loss utilizing air is introduced to a downstream side area of the refrigerant heat releasing passage on the air introduction surface of the final staged heat releasing device.

12. The vehicle air-conditioning apparatus as recited in claim 1, wherein CO₂ refrigerant is used as the supercritical refrigerant.

13. A vehicle air-conditioning heat releasing device, comprising:
a refrigerant heat releasing passage through which supercritical refrigerant passes; and
an air introduction surface for introducing refrigerant cooling air,
wherein the supercritical refrigerant passing through the refrigerant heat releasing passage exchanges heat with the refrigerant cooling air introduced from the air introduction surface,
wherein at least a part of discharge air discharged from an inside of a passenger compartment is introduced to the air introduction surface as ventilation loss utilizing air, so that the ventilation loss utilizing air is used as a part of the refrigerant cooling air, and
wherein a discharge air introduction area for introducing the ventilation loss utilizing air is provided at a downstream side area of the refrigerant heat releasing passage on the air introduction surface of the heat releasing device.

14. The vehicle air-conditioning heat releasing device as recited in claim 13, wherein an occupancy area ratio of the discharge air introduction area with respect to the total area-is set to 2 to 20%.

15. The vehicle air-conditioning heat releasing device as recited in claim 13, wherein the discharge air introduction area is provided at an area including a downstream side end portion of the refrigerant heat releasing passage on the air introduction surface.

16. The vehicle air-conditioning heat releasing device as recited in claim 13, wherein CO₂ refrigerant is used as the supercritical refrigerant.

17. A vehicle air-conditioning method in which supercritical refrigerant passing through a heat releasing passage of a heat releasing device exchanges heat with refrigerant cooling air introduced to an air introduction surface of the heat releasing device to be cooled, and the cooled refrigerant exchanges heat with air to be introduced into a passenger compartment by an evaporator,
wherein at least a part of discharge air discharged from an inside of the passenger compartment is introduced to an air introduction surface of the heat releasing device as ventilation loss utilizing air so as to utilize the ventilation loss utilizing air as a part of the refrigerant cooling air; and
wherein the ventilation loss utilizing air is introduced to a downstream side area of the refrigerant heat releasing passage on the air introduction surface of the heat releasing device.

18. A vehicle air-conditioning method in which supercritical refrigerant passing through each refrigerant heat releasing passage of first and second heat releasing devices in order exchanges heat with refrigerant cooling air introduced to each air introduction surface of the first and second heat releasing devices to be cooled, and the refrigerant cooled by the second heat releasing device arranged at a refrigerant downstream side among the first and second heat releasing devices exchanges heat with air to be introduced into a passenger compartment by an evaporator,
wherein at least a part of discharge air discharged from an inside of the passenger compartment is introduced to the air introduction surface of the second heat releasing device as ventilation loss utilizing air so as to utilize the ventilation loss utilizing air as a part of the refrigerant cooling air.

19. A vehicle air-conditioning method in which supercritical refrigerant passing through each refrigerant heat releasing passage of a plurality of heat releasing devices in order exchanges heat with refrigerant cooling air introduced to each air introduction surface of the plurality of heat releasing devices to be cooled, and the refrigerant cooled by the final staged heat releasing device arranged at a refrigerant downstream side among the plurality of heat releasing devices exchanges heat with air to be introduced into a passenger compartment by an evaporator,
wherein at least a part of discharge air discharged from an inside of the passenger compartment is introduced to the air introduction surface of the final staged heat releasing device as ventilation loss utilizing air so as to utilize the ventilation loss utilizing air as a part of the refrigerant cooling air.

20. A vehicle air-conditioning method in which supercritical refrigerant passing through each refrigerant heat releasing passage of first and second heat releasing devices in order exchanges heat with refrigerant cooling air introduced from each air introduction surface of the first and second heat releasing devices to be cooled, and the refrigerant cooled by the second heat releasing device arranged at a refrigerant downstream side among the first and second heat releasing devices exchanges heat with air to be introduced into a passenger compartment by an evaporator,
wherein at least a part of discharge air discharged from an inside of the passenger compartment is introduced to the air introduction surface of the second heat releasing device as ventilation loss utilizing air so as to utilize the ventilation loss utilizing air as a part of the refrigerant cooling air, and
wherein the ventilation loss utilizing air is introduced to a downstream side area of the refrigerant heat releasing passage on the air introduction surface of the second heat releasing device.

21. A vehicle air-conditioning method in which supercritical refrigerant passing through each refrigerant heat releasing passage of a plurality of heat releasing devices in order exchanges heat with refrigerant cooling air introduced to each air introduction surface of the plurality of heat releasing devices to be cooled, and the refrigerant cooled by a final staged heat releasing device arranged at a refrigerant downstream side among the plurality of heat releasing devices exchanges heat with air to be introduced into a passenger compartment by an evaporator,
wherein at least a part of discharge air discharged from an inside of the passenger compartment is introduced to the air introduction surface of the final staged heat releasing device as ventilation loss utilizing air so as to utilize the ventilation loss utilizing air as a part of the refrigerant cooling air, and
wherein the ventilation loss utilizing air is introduced to a downstream side area of the refrigerant heat releasing passage on the air introduction surface of the final staged heat releasing device.

22. A vehicle air-conditioning method as recited in claim 17, wherein CO₂ refrigerant is used as the supercritical refrigerant.

23. A vehicle equipped with the vehicle air-conditioning apparatus as recited in claim 1.
